(19) United States
(12) Patent Application Publication
(10) Pub. No.: US 2005/0243056 A1
(43) Pub. Date: Nov. 3, 2005

(54) Input device for portable computer

(76) Inventors: Daryl Afshin, Andover, MA (US); Keith Michael Rosiello, Shrewsbury, MA (US)

Correspondence Address: FOLEY & LARDNER LLP, 111 HUNTINGTON AVENUE, 26TH FLOOR, BOSTON, MA, 02199-7610, US

(21) Appl. No.: 11/082,109

(22) Filed: Mar. 15, 2005

Related U.S. Application Data
(60) Provisional application No. 60/553,103, filed on Mar. 15, 2004.

(51) Int. Cl. G09G 5/00

(52) U.S. Cl. 345/156

(57) ABSTRACT

A portable (or laptop) computer that includes the novel user-input device. The user input controls a variety of interface and media applications commonly found on portable computer systems. The novel input device detaches to facilitate remote operation or compact storage. Device includes user-interface hardware and manual controls for pointer, video, internet, and gaming control applications, eliminating the need for auxiliary input devices.

### RELATED APPLICATION

This application claims priority to U.S. Ser. No. 60/553,103, filed Mar. 15, 2004, the entirety of which is hereby incorporated herein by reference.

### FIELD OF THE INVENTION

The present invention related to peripheral devices for operating and controlling a computer.

### BACKGROUND

Many peripheral devices are configured to a computer to manipulate media and input data. For example, peripheral printing devices, such as printers, multifunction peripheral (MFP) devices, and copiers, are configured to render screen images and generate hard copy documents. Similarly, a keyboard is configured to input alphanumeric and symbolic information into the computer.

However, not all peripheral devices are capable of universal configuration. In such cases, if the selected device is not supported by the computer undesired results can occur ranging from no function, to unsatisfactory output, to damage of the peripheral device or the computer. Therefore, it can be appreciated that it would be desirable to have a more convenient way to enter information and execute command functions to a computer device.

### SUMMARY OF THE INVENTION

The input device of the present invention includes a housing, a plurality of input controls arranged on the housing, the input controls capable of manipulation by an operator, at least one communications port capable of interfacing with a computer, and an activation control that permits the user to activate and detach of the input device with the computer. In one embodiment, the housing includes a power supply, which may be at least one battery. In another embodiment, the communications port interfaces wirelessly with the computer.

In another aspect, the invention provides a method of using an input device comprising: obtaining a computer, obtaining an input device capable of interfacing with the computer, and interfacing the input device with the computer.

### SUMMARY OF THE DRAWINGS

FIG. 1A is a schematic front view of the portable computer in one embodiment, in an operating position, with novel input device attached.

FIG. 1B is a schematic side view of the portable computer in one embodiment, in an operating position, with novel input device attached.

FIG. 1C is a schematic top view of the portable computer in one embodiment, in an operating position, with novel input device attached.

FIG. 2A is a schematic top view of the portable computer in one embodiment, in an operating, position, with the novel input device detached.

FIG. 2B is a schematic front view of the portable computer in one embodiment, in an operating position, with the novel input device detached.

FIG. 3A perspective schematic view of the portable computer, in the recessed feature embodiment, with novel input device attached.

FIG. 3B perspective schematic view of the portable computer, in the recessed feature embodiment, with novel input device detached.

### DESCRIPTION OF THE INVENTION

The present invention provides an input device for a portable computer. The device is designed for universal compatibility, and is further designed to be light and compact, and to provide a plurality of input functions.

Most peripheral devices are wired apparatus with low mobility, while the notebook computer is a product with high mobility. After the notebook computer is connected to a peripheral device, the movable range thereof is restricted by the wire and the convenience thereof is greatly reduced. At present, the connections between the notebook computer and the peripheral device may be roughly divided into the following four kinds of connections.

Direct Connection.

The notebook computer may be directly connected to wired peripheral devices through the built-in external ports on its casing. In this way, the user has to inconveniently disconnect or connect various connection wires after the notebook computer has been taken out or in.

Network Connection.

The notebook computer may be connected to wired peripheral devices on the network through the wireless or wired network. Generally, the network setup is too complicated for a typical computer user.

Bluetooth Connection.

The notebook computer can access peripheral devices via Bluetooth modules where the notebook computer and the peripheral devices are both equipped with built-in Bluetooth modules. In this architecture, all the peripheral devices have to be equipped with built-in Bluetooth modules so as to enable the notebook computer to be moved. Peripheral devices with the built-in Bluetooth modules are more expensive than the wired peripheral devices.

Integrated Device Connection.

The notebook computer has an optional integrated device to be connected to various peripheral devices. The integrated device may be, for example, a docking station, an external port replicator, or the like. The wired peripheral devices may be connected to the integrated device through their original interfaces, and then the integrated device may be connected to the notebook computer through a single connector. The user only has to connect the notebook computer to the docking station or external port replicator after the notebook computer has been taken in. Then, the user may use or access the peripheral devices.

Since the conventional connection ways cannot thoroughly solve the connection problems between the portable computer and the peripheral devices, it is necessary to provide a novel architecture to enable the portable computer to freely access the peripheral devices without influencing the mobility thereof.

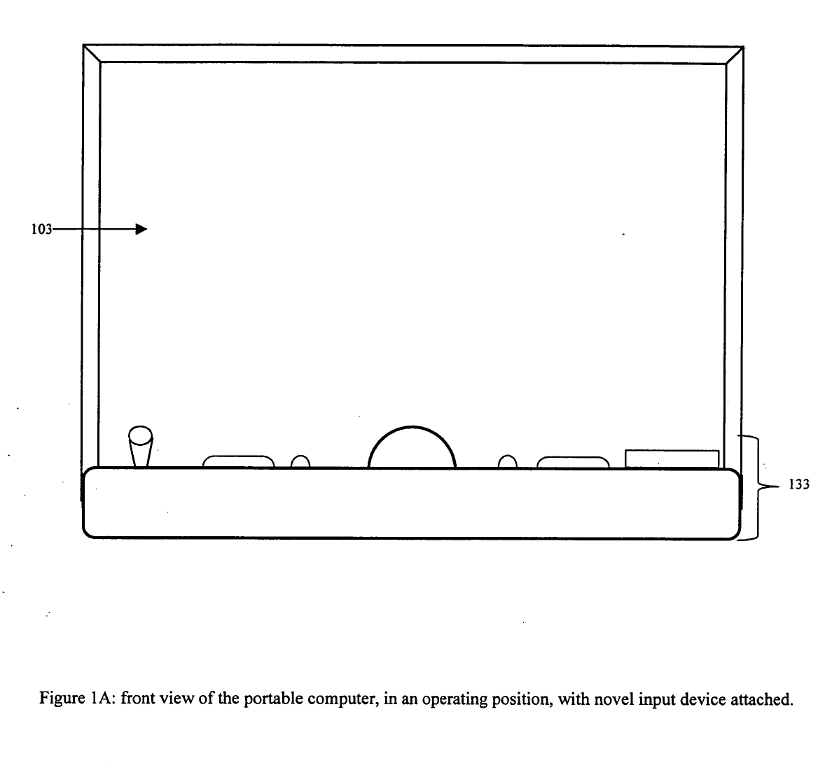

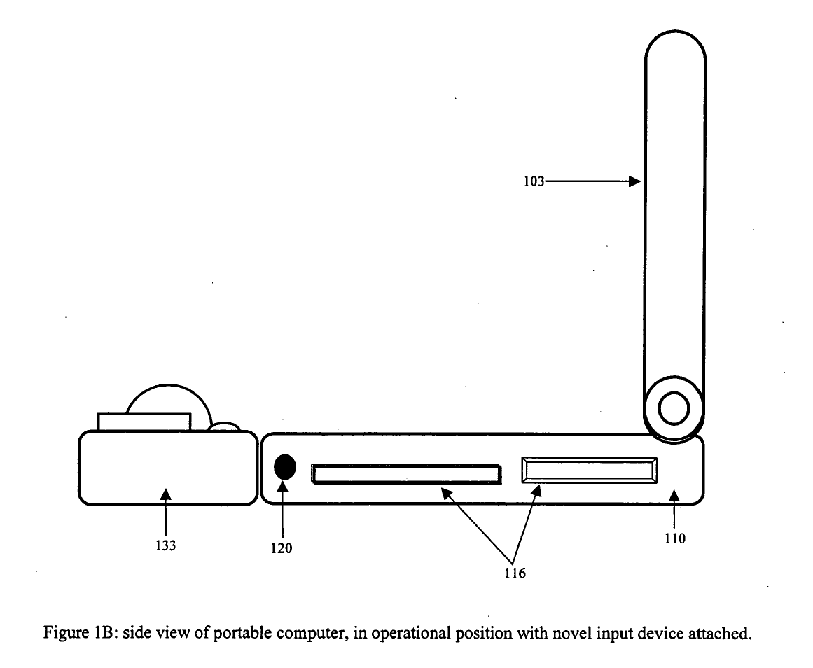

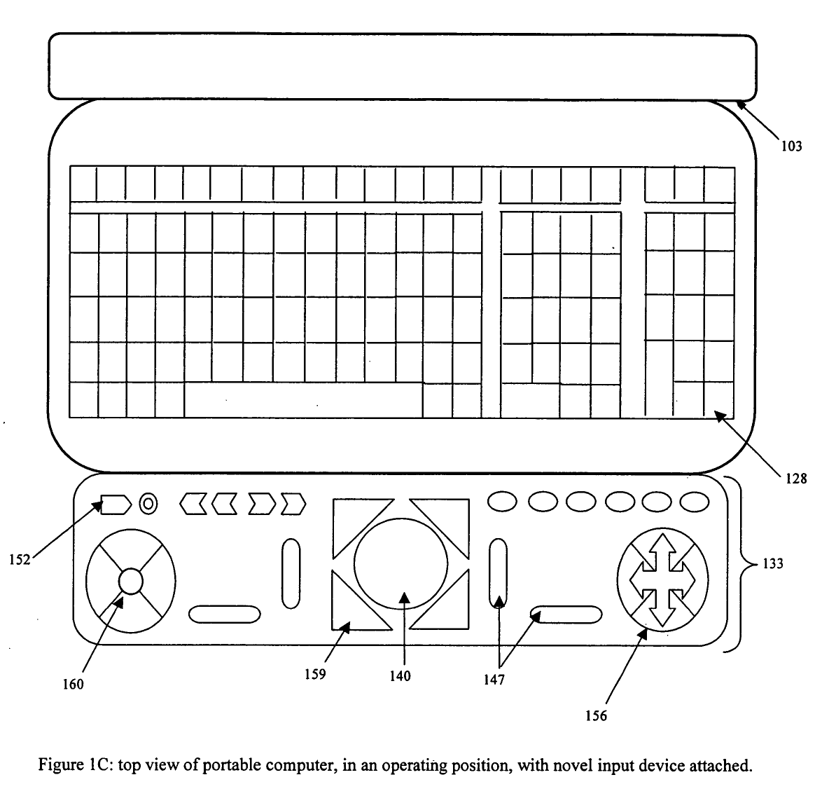

A typical portable computer device is shown in FIG. 1. The screen (103) unfolds from the body of the device, thereby permitting viewing by an operator. The input device (133) of the present invention is shown adapted to the front of the portable computer.

FIG. 1B shows a side view of the portable computer, illustrating the main case (110) containing the computer hardware, electronics, communication ports, and power supply. The screen (103) is mounted on a pivot to create two functional positions for the unit, shown open. The media drives (116), keyboard (128) and multi-function input device (133) are all mounted in or to the main case to accommodate user access. The novel input device that contains multiple control clusters with commonly used computer input and control components is also attachable to the main case. An activation feature (120), such as a button or slide,. allows the user to prompt the detachment of the novel input device. When detached, the novel input device continues to function as a control and communicates with the main computer via infrared or radio frequency signals. The novel input device uses self-contained and commonly available disposable or rechargeable batteries as a power source during remote operations. The control clusters are used to supply input from the user to a multitude of software applications running on the associated computer and eliminate the need for any other peripheral input device. The novel input device improves upon prior art by eliminating the need for peripheral, application-specific input devices, for example pointing devices and game controllers, by accommodating all the portable computer users requirements in a single multi-functional unit.

FIG. 1C shows an embodiment of the input device having a trackball (140) and scroll wheel style (147) controls, standard push buttons (152), force sensitive buttons (159), directional sensitive control pads (156), and a directional gaming controller (160).

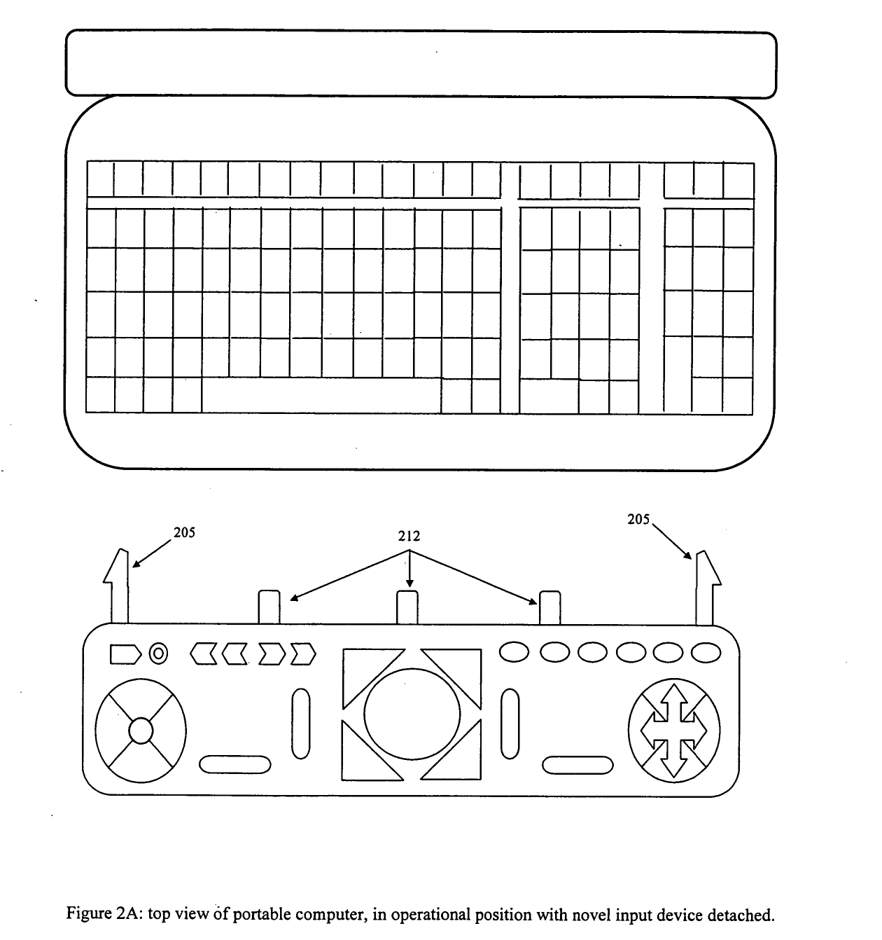

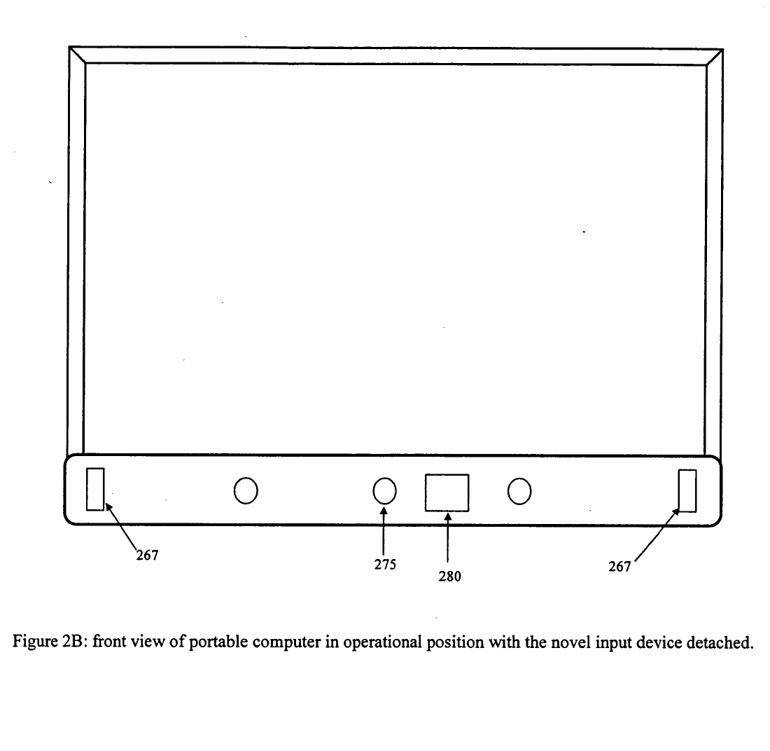

FIG. 2A shows the novel input device can detach from the portable computer main case, proximal to the keyboard, using integral features (205 & 267) of each component to align and connect the device to the computer. One or more mating communication ports (212 & 275), integral to both the main computer and the novel input device are connected when the units are attached. It is preferred that the communication ports use a high bandwidth communication standard, such as LAN or Ethernet ports, parallel ports, Universal Serial Bus 2.0, Firewire (IEEE 1394), and the like. To accommodate remote communication, transmitting and receiving units (280) are preferable mounted in each component, and permit communication wirelessly, without physical contact between the computer and the input device. A variety of wireless data communication standards are know, generally referred to as WiFi, (for example, transmission interfaces meeting the Bluetooth or IEEE 802.11a/b/g specifications) which are appropriate for wireless control operations. FIG. 2B illustrates the computer with the input device detached. Shown are the communication ports and wireless communication devices.

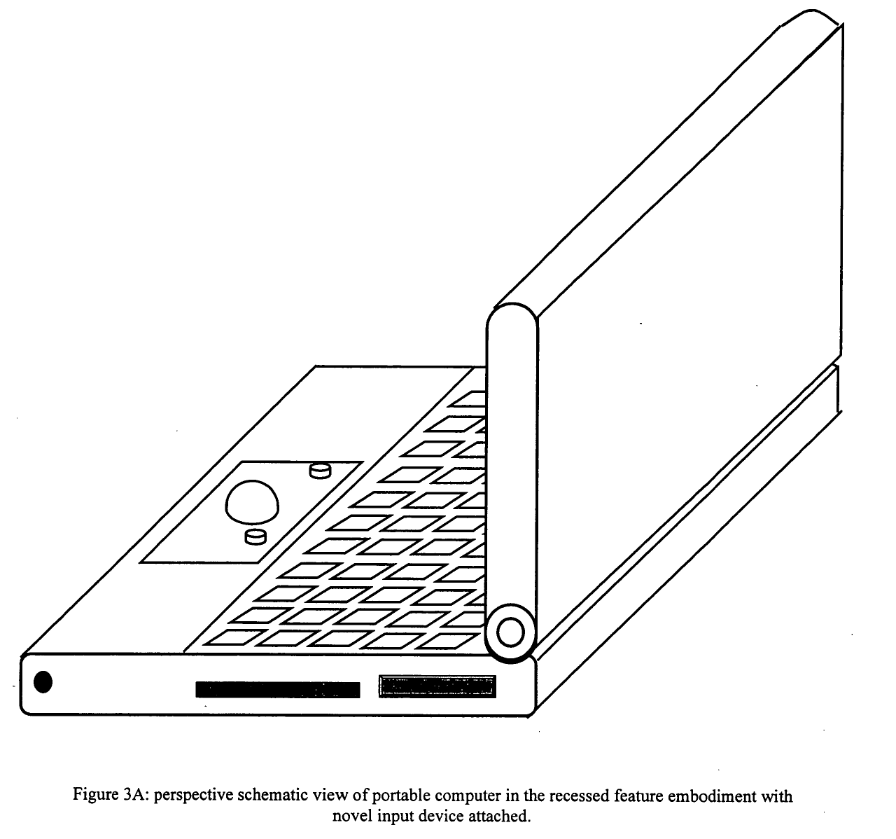

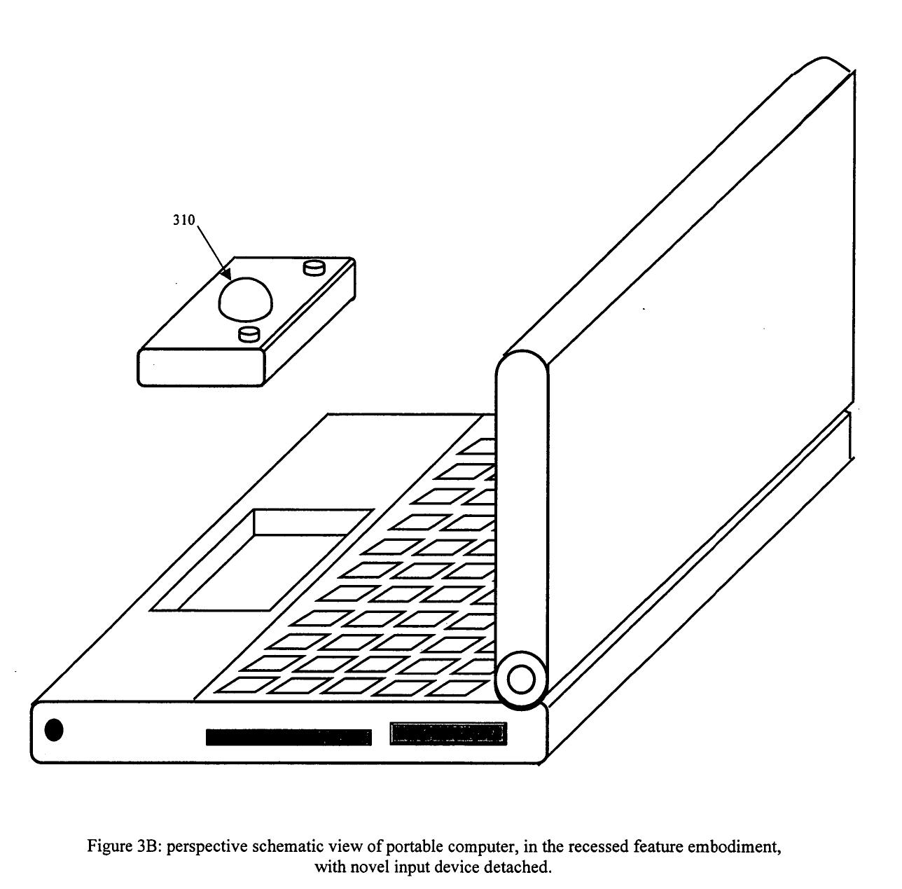

A further embodiment is shown in FIG. 3A and 3B. In this embodiment, the novel input device has a compact form and when attached is contained in a recessed feature of the main case. The feature is located on the main case to accommodate the user when the device is docked, proximal to the keyboard in this embodiment. The input control clusters on the device in this embodiment include a combination trackball and traditional surface contact pointer (310) that functions effectively in either an upright trackball position or an inverted surface contact position. Other input controls included on this embodiment of the device include a gaming directional controller that can be recessed into the body of the device when not in use.

To use the input device, an operator attaches the input device to the computer prior to initiating power in the computer. In preferred embodiments, the input device is hot swappable, and can be adapted to or disengaged from the computer without disrupting the power. Prior to first use, the operator loads software modules, i.e., drivers on the computer, which instruct the computer that the input device is present, and permit it to be used to input data or commands into the computer. Once a driver is installed, it is preferred that no further setup needs to be performed by the operator. In a more preferred embodiment, the input device wirelessly signals its proximity to the computer, which hands over command and input functions to the input device.

One skilled in the art can appreciate the variety of physical forms the novel input device can take to accommodate current application and consumer needs. For example, the use of keys or keypad in a control cluster, the inclusion of a mechanisms to support application feedback (lights or vibration for example), the use of sound devices such as speakers or microphones in the input device, or the use of small video or touch screens in a control cluster. Other such variations with be apparent to a skilled artisan in view of the teachings provided herein, and are considered within the scope of the invention.

1. An input device comprising: a housing, a plurality of input controls arranged on the housing, the input controls capable of manipulation by an operator, at least one communications port capable of interfacing with a computer, and an activation control that permits the user to activate and detach of the input device with the computer.

2. The device of claim 1, wherein the housing further comprises a power supply.

3. The device of claim 2, wherein the power supply is at least one battery.

4. The device of claim 1, wherein the communications port interfaces wirelessly with the computer.

5. A method of using an input device comprising: obtaining a computer, obtaining an input device capable of interfacing with the computer, and interfacing the input device with the computer.
